(19) United States
(12) Patent Application Publication
(10) Pub. No.: US 2007/0298244 A1
(43) Pub. Date: Dec. 27, 2007

(54) BONDING MATERIALS HAVING PARTICLE WITH ANISOTROPIC SHAPE

(76) Inventors: YUSUKE YASUDA, Hitachi (JP); Toshiaki Morita, Hitachi (JP); Toshiaki Ishii, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/766,124

(22) Filed: Jun. 21, 2007

(30) Foreign Application Priority Data
Jun. 21, 2006 (JP) 2006-170851

(51) Int. Cl. B32B 5/16

(52) U.S. Cl. 428/328

(57) ABSTRACT

An object of the present invention is to provide a bonding material that is excellent in shear strength and a capability of heat radiation of a bonding layer and can be formed into a sheet. The present invention has a feature of providing a bonding material comprising metal fibers each of which is coated on its surface with an organic material or a metal oxide, has an aspect ratio not more than 2, and has a longitudinal length equal to or less than 100 μm; and metal particles each of which is coated on its surface with an organic material or a metal oxide, has an aspect ratio equal to or less than 1.5, and has a particle size equal to or less than 100 nm, wherein sintering of the metal particles forms metallic bonds between the bonding material and surfaces of members to be bonded, thereby bonding the members to be bonded together.

### BACKGROUND OF THE INVENTION

1. Field of the invention

The present invention relates to bonding materials used for semiconductor modules.

In non-insulated type semiconductor devices, which is one of power semiconductor devices used for inverters and so on, a member fixing semiconductor elements also functions as one of electrodes of semiconductor devices. For example, in a semiconductor device in which power transistors are mounted on a fixing member by using a Sn—Pb soldering flux, the fixing member (a base member) functions as a collector electrode of the power transistors. This collector electrode portion carries a current equal to or greater than several amperes during operation of the semiconductor device, and thus the transistor chips produce heat. In order to prevent characteristics from becoming unstable or life from decreasing due to the heat generation, a soldered portion has to secure a capability of heat radiation and long term reliability (heat resistance). In order to secure a capability of heat radiation and reliability for a soldered portion, a material having a high capability of heat radiation is necessary.

Also in insulated type semiconductor devices, in order to operate semiconductor elements with safety and stability, it is necessary to efficiently radiate heat generated on operation of the semiconductor devices to the outside of the semiconductor devices, and to secure connection reliability of a soldered portion.

JP-A-2004-165066 discloses a conductive filler, a conductive paste comprising a needle-shaped conductive filler the surface of which is coated with solder and a binder resin. JP-A-2004-165066 achieves reduced resistance by connecting the fillers with soldering.

JP-A-2004-272364 discloses a bonding process where metal particles each of which is coated on its surface with an organic material is used, the metal particles are heated to decompose the organic material and the sintering phenomenon of metal particles is used for bonding. In this technique, metal particles after being bonded turn into a bulk metal, thereby having very high heat resistance, reliability, and a high capability of heat radiation.

On the other hand, a shift toward lead free solders is demanded at present, whereas no alternative materials for high temperature solders have emerged yet. Use of layer solder is absolutely essential in packaging, emergence of materials alternative to high temperature solders have been demanded. Therefore, bonding techniques using metal particles have also been expected as the advent of materials alternative to high temperature solders.

2. Description of related art

In the module disclosed in JP-A-2004-165066, a bonding method using solder mainly consisting of Sn is used for the bonding between a circuit board and circuit components, and between circuit components and a parent board. Therefore, it is difficult to provide temperature layers for various soldering necessary for fabricating semiconductor devices.

Furthermore, in semiconductor devices on which power semiconductor elements are mounted, Sn materials having low melting points are used such as a eutectic composition consisting of Sn and Pb as a solder material. Therefore, it has been difficult to use the semiconductor devices under high temperature circumstances (for example at 180° C. or higher) On the other hand, the bonding process using the metal particle material is reliable under high temperature circumstances. However, the process does not provide sintered silver after bonding with sufficient bonding strength and a capability of heat radiation as compared with bulk silver. In addition, in this bonding process, it is advantageous in terms of handling as a bonding material or simplifying the bonding process to apply pressure to a bonding material to form and use a sheet in an actual volume production process. On the other hand, use of only conventional metal particles does not provide sufficient strength of the sheet, and thus it is difficult to use it as a sheet material.

In addition, the conductive paste using the conductive filler is far inferior in a capability of heat radiation and heat resistance to a bulk metal because the conductive paste uses an organic material as a binder resin. Furthermore, it is difficult to form the material into a sheet because the material is used as a paste.

The present invention has been accomplished in order to overcome the problems. An object of the present invention is to provide a bonding material that is excellent in shear strength and a capability of heat radiation of a bonding layer and can be formed into a sheet.

### SUMMARY OF THE INVENTION

In order to overcome the problems, a feature of the present invention is to provide a bonding material comprising metal fibers each of which is coated on its surface with an organic material or a metal oxide, has an aspect ratio greater than 2, and has a longitudinal length equal to or less than 100 μm; and metal particles each of which is coated on its surface with an organic material or a metal oxide, has an aspect ratio equal to or less than 1.5, and has a particle size equal to or less than 100 nm, wherein sintering of the metal particles forms metallic bonds between the bonding material and surfaces of members to be bonded, thereby bonding the members to be bonded together.

In addition, a feature of the present invention is to provide a bonding material comprising metal fibers each of which is coated on its surface with an organic material or a metal oxide, has an aspect ratio greater than 2, and has a longitudinal length equal to or less than 100 nm, wherein sintering of the metal fiber forms metallic bonds between the bonding material and surfaces of members to be bonded, thereby bonding the members to be bonded together.

In addition, a feature of the present invention is to provide a bonding material comprising a mixture of metal fibers each of which is coated on its surface with an organic material or a metal oxide, has an aspect ratio greater than 2, and has a longitudinal length equal to or less than 100 μm; and metal particles each of which is coated on its surface with an organic material or a metal oxide, has an aspect ratio equal to or less than 1.5, and has a particle size equal to or less than 100 nm.

Furthermore, a feature of the present invention is to form the bonding materials to have the shape of a sheet.

A feature of the present invention is to provide an electronic device having a structure wherein a metal wiring formed on a surface of a substrate and an electronic component on the surface of which a metal electrode is formed are bonded together via a layer made of the bonding material.

The bonding material according to the present invention comprises metal fibers each of which has an aspect ratio greater than 2, and has a longitudinal length equal to or less than 100 μm, whereby the metal fibers entangle each other when the bonding material is formed into a sheet, and contacts among the metal fibers makes it possible to increase strength of the sheet. In addition, combined use of the metal fibers and metal particles each of which has a particle size equal to or less than 100 nm provides a constitution in which fine metal particles exist in gaps among the metal fibers. Therefore, it is possible to provide a sintered object having fewer gaps when the bonding material is sintered by heating, and thus it is possible to obtain characteristics such as heat resistance or a capability of heat radiation similar to those of a bulk metal.

According to the present invention, a bonding material that is excellent in shear strength and a capability of heat radiation of a bonding layer and can be formed into a sheet can be provided.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a schematic view showing a mixed material comprising Au rods and Au particles;

FIG. 2 is a distribution chart of aspect ratios in a bonding material;

FIG. 3(a) and FIG. 3(b) illustrate a structure of a non-insulated type semiconductor device according to an embodiment of the present invention;

FIG. 4 illustrates a subassembly portion of an insulated type semiconductor device according to the present invention;

FIG. 5 is an enlarged schematic view showing semiconductor elements and a bonding portion to a substrate;

FIG. 6 illustrates a subassembly portion of a non-insulated type semiconductor device according to another embodiment of the present invention; and

FIG. 7 is an enlarged schematic view showing semiconductor elements and a bonding portion to a substrate.

### DESCRIPTION OF SYMBOLS

1 . . . metal fiber;

2 metal particle;

301 . . . semiconductor element (MOSFET);

302 . . . ceramic insulating substrate;

302a . . . copper plate;

303 . . . base member;

304 . . . epoxy resin case;

305 . . . bonding wire;

306 . . . epoxy resin top;

307 . . . silicone gel resin;

308, 309 . . . denote bonding layers; and

310 . . . terminal.

### DETAILED DESCRIPTION OF THE INVENTION

Hereinafter, embodiments of the present invention will be explained specifically referring to drawings.

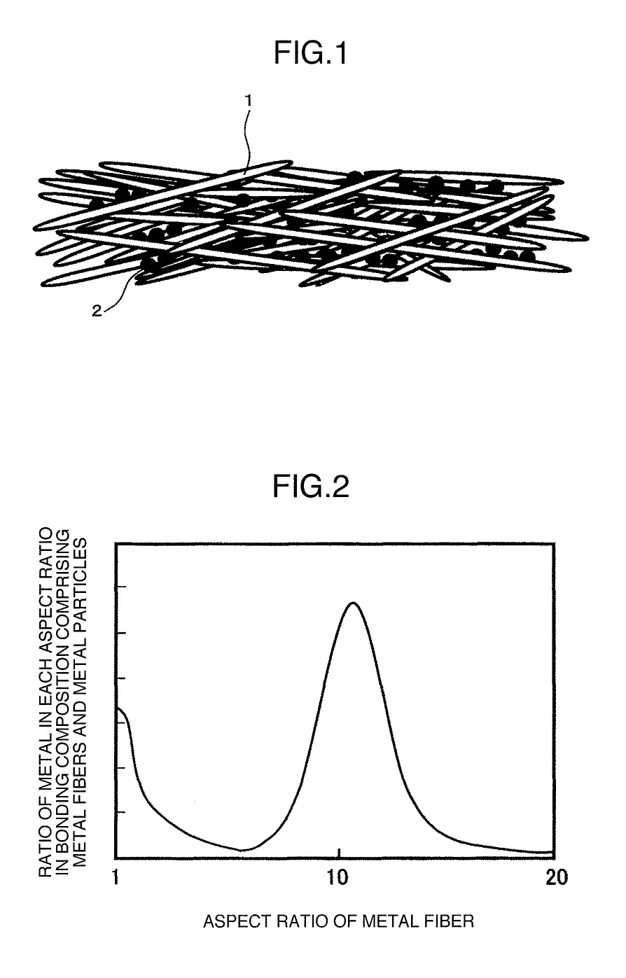

FIG. 1 is a schematic view showing a bonding material according to an embodiment of the present invention. The bonding material according to the present invention comprises a mixture of plural metal fibers 1 each of which is coated on its surface with an organic material or a metal oxide, has an aspect ratio greater than 2, and has a longitudinal length equal to or less than 100 μm; and plural metal particles 2 each of which is in gaps of the metal fibers 1, is coated on its surface with an organic material or a metal oxide, has an aspect ratio equal to or less than 1.5, and has a particle size equal to or less than 100 nm. The metal particles 2 are contained in FIG. 1, however, the bonding material may not contain the metal particles 2 when metal fibers each having a longitudinal length equal to or less than 100 nm is used as the metal fibers 1. The bonding material according to the present invention is placed between members to be bonded, heated to melt the surfaces of the metal fibers or the metal particles, and the metal fibers and the metal particles, or the surfaces of members to be bonded and the metal fibers or the metal particles are bonded by metallic bonds, whereby the members to be bonded can be bonded together. In addition, combined application of heat and pressure on bonding is preferable in view of strength, thermal conduction characteristics, and the like of a bonded member.

In the present invention, the reason of mixing at least metal particles or metal fibers each of which has a size equal to or less than 100 nm in a bonding material is that the bonding material does not play the role of a bonding material because sintering in lower temperatures does not occur with metal particles or metal fibers each of which does not has a particle size (or a longitudinal length) equal to or less than 100 nm.

In addition, each of the metal particles to be used is defined to have an aspect ratio equal to or less than 1.5 because the metal particles play the role of filling the gaps among metal fibers on sintering, and the metal particles each having an aspect ratio greater than 1.5 do not play the role of filling the gaps among metal fibers.

In addition, each of the metal fibers is defined to have a longitudinal length equal to or less than 100 μm because metal fibers each having a longitudinal length greater than 100 μm cause severe irregularities of the sheet surface, resulting in reduction of bonding strength at the bonding interface. Furthermore, sheet strength on forming a sheet also begins to decrease.

On the other hand, each of the metal fibers to be used is defined to have an aspect ratio not more than 2 because use of metal fibers each having an aspect ratio greater than that realize effects of increasing sheet strength due to contacts among the metal fibers.

In the present invention, the organic material coating the metal fibers 1 or the metal particles 2 may be an organic material that provides effects of preventing the metal fibers 1 or the metal particles 2 from agglomerating by coating around the metal fibers 1 or the metal particles 2. Examples of the organic material may include: alkyl amines such as octylamine, hexyldiamine, decylamine, or methylenediamine; alkyl carboxylic acids such as octanoic acid or hexanoic acid; alkylthiols, and the like.

In addition, besides the examples, as the organic material coating the metal fibers 1, surfactants used in preparing the metal fibers 1 may be used as a protective film (an organic material). An example of such a compound is hexadecyl trimethyl ammonium bromide (CTAB). In addition, polymeric materials may be used as the organic material. Examples of the polymeric materials may include: polyvinyl pyrrolidone (PVP), polyvinyl alcohol (PVA), polyethylene glycol (PEG), polyacrylonitrile (PAA) and the like.

In the present invention, as with the organic material, the metal oxide coating the metal fibers 1 or the metal particles 2 may be a metal oxide that provides effects of preventing the metal fibers 1 or the metal particles 2 from agglomerating by coating around the metal fibers 1 or the metal particles 2. Oxides of materials constituting the metal fibers 1 or the metal particles 2 may be used.

A sheet material for bonding according to the present invention is formed by applying pressure to the bonding material. It should be noted that a method for forming a sheet is not restricted thereto.

The bonding material according to the present invention may be used as a paste material by dispersing the bonding material into an organic solvent. Examples of the organic solvent may include, but are not limited to, toluene, triethylene glycol, α-terpineol, and the like.

In addition, there are the following methods of applying the bonding material in which the metal fibers and the metal particles are dispersed that is processed into a paste: a method of spraying the paste from fine nozzles by ink jet method to apply the paste to an electrode on a substrate or a connecting portion of an electronic component; a method of using a metal mask or mesh mask in which portions to be applied are not covered to apply the paste only portions necessary to be applied; a method of applying the paste to portions necessary to be applied with a dispenser; a method of applying a water repellent resin containing silicone, fluorine, or the like with a metal mask or mesh mask in which portions to be applied are not covered, or applying a photosensitive water repellent resin to a substrate or an electronic component, conducting exposure and development to remove the resin in portions to which the paste comprising fine particles or the like are applied, and then applying the bonding paste to the openings; and a method of applying a water repellent resin to a substrate or an electronic component, subsequently removing the resin, with a laser, in portions to which the paste comprising metal particles are applied, and then applying the bonding paste to the openings. These methods may be combined depending on the area or the shape of electrodes to be bonded.

As for the metal particles each of which has a particle size equal to or less than 100 nm according to the present invention, any metal particles each of which has a particle size equal to or less than 100 nm and is coated on its surface with an organic material or a metal oxide may be used. There may be used at least one metal or an alloy consisting of two or more metals selected from gold, silver, copper, platinum, palladium, rhodium, osmium, ruthenium, iridium, iron, tin, zinc, cobalt, nickel, chromium, titanium, tantalum, tungsten, indium, silicon, aluminum, and the like. In particular, metal particles consisting of Au or an Au alloy and metal particles consisting of Ag or an Ag alloy are preferably used alone or in combination of two or more of the particles. In addition, as the metal fibers, there may be used metal fibers consisting of Au or an Au alloy; metal fibers consisting of Ag or an Ag alloy; metal fibers in which nickel particles are used as cores and the surface of the cores are plated with Au, an Au alloy, Ag or an Ag alloy; or metal fibers in which the surfaces of copper core particles are plated with nickel, and the surfaces of the nickel-plating is further plated with Au, an Au alloy, Ag or an Ag alloy.

The mixture of the metal fibers and the metal particles is effectively used by dispersing the mixture into water, an organic solvent such as a surfactant, or the like that interacts with each surface of the particles and is easily removed at the bonding temperature in order not to cause agglomeration and fusing of each particles during storage or an application process.

As described above, the present invention provides a packaging method applying a phenomenon in which metal fibers are mixed with metal particles, and bonding is achieved by agglomeration of the metal composition containing the metal particles each of which has a particle size equal to or less than 100 nm. This packaging technique uses a phenomenon that metal particles agglomerate and turn into a bulk metal. Therefore, the bonded portion after bonding has much higher heat resistance than the case of using the conventional solders. In addition, when metal particles added at the same time, semiconductor elements and electrodes and the like formed on a wiring substrate are bonded via the agglomeration layer, it is possible to conduct the bonding in lower temperatures and with lower pressure.

On the other hand, by forming a bonding layer comprising metal fibers each of which is coated on its surface with an organic material or a metal oxide; and metal particles each of which is coated on its surface with an organic material or a metal oxide and has a particle size equal to or less than 100 nm on electrodes provided on an active area of an conductive element and a mounting portion of a wiring substrate on which the electrodes are mounted, damage hardly occurs on bonding and the mounting portions of semiconductor elements are not melted in a heating process after the semiconductor elements are mounted on a wiring substrate. Therefore, it is possible to realize miniaturization and high reliability of semiconductor devices. In addition, mixing of metal fibers increases sheet strength when a material is formed into a sheet material, and thereby providing extreme ease of handling. Furthermore, mixing of such metal fibers makes it possible to increase shear strength or a capability of heat radiation at the bonding portion after bonding, thereby realizing bonding with higher reliability.

### EXAMPLE

Hereinafter, Examples of the present invention will be explained. In the Examples, metal fibers each of which has an aspect ratio greater than 2 and less than 50, and has a longitudinal length equal to or less than 100 μm are referred to as metal rods; and metal fibers each of which has an aspect ratio equal to or greater than 50, and has a longitudinal length equal to or less than 100 μm are referred to as metal wires. In addition, every metal particle used in the examples had an aspect ratio equal to or less than 1.5.

### Examples 1 to 5, and Comparative Examples 1 to 3

As for methods for manufacturing metal fibers, there are several research reports. The methods are known by Chem. Mater. 2002, 14, 4736-4745; JP-A-2005-97718; Adv. Mater. 2002, 14, 80-82; and the like. In the present Examples, a synthetic method disclosed in JP-A-2005-97718 was used to synthesize the Au rods, and a synthetic method disclosed in Adv. Mater. 2002, 14, 80-82 was used to synthesize the Au wires.

FIG. 1 is a schematic view showing the case of mixing the Au rods the surfaces of which are coated with an organic material with the Au particles the surfaces of which are coated with an organic material, which is an embodiment according to the present invention. The Au particles used in the Examples had an average particle size of about 10 nm. Each of the Au rods used in the Examples had an aspect ratio of about 10, and had a longitudinal length of about 100 nm. In addition, as shown in FIG. 2, the bonding material has a feature of having at least two or more peaks in a distribution chart of aspect ratios.

In addition, each of Au wires used in the Examples had an aspect ratio of about 100, and had a longitudinal length of about 5 μm.

In the Examples, alkylamine was used as the organic material coating the Au particles. CTAB was used as the organic material coating the Au rods and the Au wires.

In Example 1, the Au particles and the Au rods were mixed in toluene in a weight ratio of 1:1. Toluene is an organic solvent into which both the Au particles and the Au rods can be dispersed. The Au particles and the Au rods were dispersed uniformly by using ultrasonic waves to prepare a mixed paste material consisting of the Au particles and the Au rods.

Furthermore, thus obtained mixed paste was dried under a reduced pressure at 60° C. to remove the organic solvent. Thus obtained mixed powder of the Au particles and the Au rods was subjected to pressure with a pressing machine to form the powder into a sheet.

In addition, in Example 2, a paste material in which the Au particles and the Au rods were mixed in toluene in a weight ratio of 9:1 was prepared. According to the method as with above, a bonding material having the shape of a sheet was formed.

In addition, in Example 3, a paste material in which the Au particles and the Au rods were mixed in toluene in a weight ratio of 1:9 was prepared. According to the method as with above, a bonding material having the shape of a sheet was formed.

In addition, in Example 4, a paste material in which the Au wires were dispersed into toluene was prepared. According to the method as with above, a bonding material having the shape of a sheet was formed.

In addition, in Example 5, a paste material in which the Au particles and the Au rods were mixed in toluene in a weight ratio of 1:1 was prepared. According to the method as with above, a bonding material having the shape of a sheet was formed.

On the other hand, in Comparative Example 1, a paste material in which only the Au particles were dispersed in toluene was prepared. According to the method as with above, a bonding material having the shape of a sheet was formed.

In addition, in Comparative Example 2, a paste material consisting of a resin composition including scaly Au particles (50 wt %) and an epoxy resin (50 wt %).

In addition, in Comparative Example 3, a paste material consisting of a resin composition including the Au particles (9 wt %), the Au rods (1 wt %), scaly Au particles (40 wt %), and an epoxy resin (50 wt %).

As for bonding materials prepared in Examples 1 to 5 and Comparative Examples 1 to 3, results of measuring Vickers hardness, shear strength, and thermal conductivity are shown in Table 1. In Table 1, each characteristic is shown as a ratio compared with characteristic of Comparative Example 1 as 100%.

TABLE 1

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| Au Particles (%) | 50 | 90 | 10 | 0 | 50 | 100 | 0 | 9 |
| Au Rods (%) | 50 | 10 | 90 | 0 | 0 | 0 | 0 | 1 |
| Au Wires (%) | 0 | 0 | 0 | 100 | 50 | 0 | 0 | 0 |
| Scaly Au | 0 | 0 | 0 | 0 | 0 | 0 | 50 | 40 |
| Particles (%) | | | | | | | | |
| Epoxy Resin (%) | 0 | 0 | 0 | 0 | 0 | 0 | 20 | 50 |
| Vickers | 500 | 120 | 600 | 900 | 620 | 100 | — | — |
| Hardness (%) | | | | | | | | |
| Shear | 150 | 130 | 135 | 110 | 130 | 100 | 30 | 33 |
| Strength (%) | | | | | | | | |
| Thermal | 115 | 105 | 110 | 102 | 107 | 100 | 20 | 25 |
| Conductivity (%) | | | | | | | | |

The values of Vickers hardness in Examples 1 to 5 in which Au rods or Au wires were mixed were larger than that in Comparative Example 1 without Au rods or Au wires. This is because, in the case of mixing the Au rods with the Au particles, entanglement among the Au rods increases form stability of a sheet, thereby increasing Vickers hardness, in comparison with the case of preparing the material from only the Au particles. On the other hand, sheet strength also depends considerably on the ratio of the Au rods to be mixed. As the ratio of the Au rods increases, Vickers hardness increases. As the ratio of the Au rods increases, points where the Au rods entangle each other increase, whereby the shape becomes extremely stable as a whole. In addition, a sheet material formed from only the Au wires had a value of about 9 times as large as that of a sheet material formed from only the Au particles in Vickers hardness.

In shearing tests, samples obtained by bonding copper disc pieces with the bonding materials were used, and strengths of bonding portions were measured under pure shearing stress. Conditions on bonding were pressure of 2.5 Mpa, bonding temperature of 350° C. and bonding time of 2 minutes and 30 seconds. As for the size of each of the test pieces, the upper side had a diameter of 5 mm and a thickness of 2 mm, and the lower side had a diameter of 10 mm and a thickness of 5 mm. The shear strength depends on the mixing ratio of the Au particles and the Au rods. A tendency was observed that as the ratio of the Au rods increased, the shear strength also increases, and then when the ratio increased further, the value of the shear strength decreased. The reason of this is considered that increase of the ratio of the Au rods increases the ratio of fibrous matters having bulk properties, thereby resulting in increase of the shear strength; however, the ratio of the Au rods exceeding a certain ratio causes increase of vacancies in bonding portions. In addition, it may also be considered that the Au rods arranged in the same direction in some portions, resulting in increase of filling factor before bonding, whereby high density sintering were possible in those portions.

In addition, as to thermal conductivity, increase of thermal conductivity was observed in Examples 1 to 5 in which metal rods or metal wires were mixed in comparison with Comparative Example 1, as with the shear strength.

Furthermore, the bonding materials of Examples 1 to 5 exhibited values of about 3 times or larger in properties of shear strength and thermal conductivity than the bonding materials of Comparative Examples 2 and 3.

The sheet strength, bonding strength and thermal conductivity considerably depend on a mixing ratio of the metal rods and the metal wires, and aspect ratios of the metal fibers. Therefore, in order to realize desired functions, it is necessary to optimize these parameters.

Next, Table 2 shows the change of Vickers hardness when aspect ratios of the Au rods were changed.

### [Table 2]

TABLE 2

| | Aspect Ratio of Metal Rod | | | | |
|---|---|---|---|---|---|
| | 1 | 5 | 10 | 20 | 50 |
| Vickers Hardness (%) | 100 | 110 | 120 | 250 | 400 |

Bonding materials used in this evaluation were sheets prepared from only the Au rods. Vickers hardness increases as the aspect ratios of the Au rods increase. This reason is considered that as the aspect ratios of the Au rods increase, points where the Au rods entangle each other increase, whereby the shape becomes stable further. Therefore, use of metal fibers having large aspect ratios increases the strength.

### Example 6

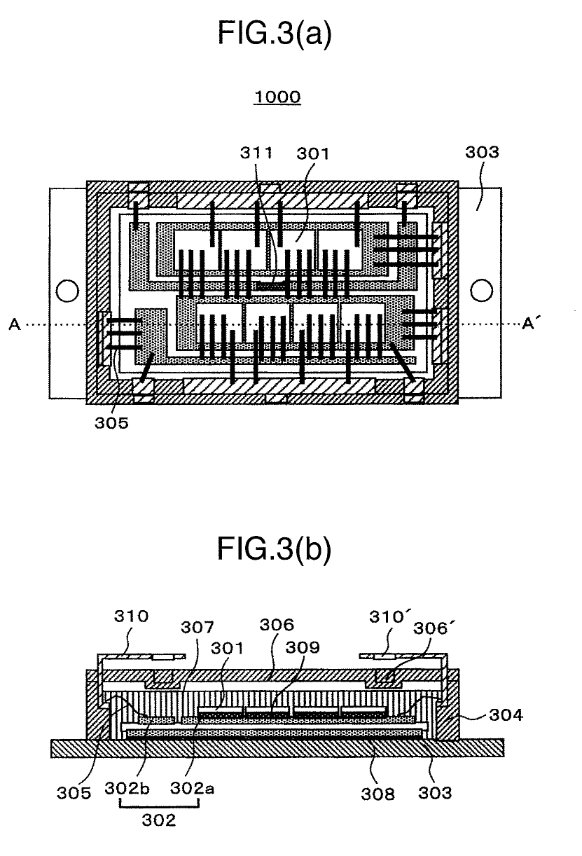

FIG. 3 illustrates structures of a non-insulated type semiconductor device according to an embodiment of the present invention. FIG. 3(a) is a top view, and FIG. 3(b) is a section view of section A-A′ in FIG. 3(a). A semiconductor element (MOSFET) 301 is mounted on a ceramic insulating substrate 302, and the ceramic insulating substrate 302 is mounted on a base member 303. Then an epoxy resin case 304, a bonding wire 305 and an epoxy resin top 306 are provided. And the same case is filled with a silicone gel resin 307. The ceramic insulating substrate 302 is bonded on the base member 303 via a bonding layer 308 consisting of Au particles each of which are coated with an organic material and has an average particle size of about 10 nm and Au rods each of which has an aspect ratio of about 10, has a longitudinal length of about 100 nm, and is coated with an organic material, in a weight ratio of 1:1. Eight MOSFET elements 301 made of Si are bonded on a copper plate 302a of the ceramic insulating substrate 302 via a bonding layer 309 consisting of Au particles each of which is coated with an organic material and has an average particle size of about 10 nm and Au rods each of which has an aspect ratio of about 10, has a longitudinal length of about 100 nm, and is coated with an organic material, in a weight ratio of 1:1. As for bonding using the bonding layers 308 and 309 comprising Au particles, first, bonding sheet materials are placed on the copper plate 302a (which is plated with Ni) and the base member 303, respectively. The bonding sheet materials are obtained by applying pressure with a pressing machine to a metal mixed material consisting of Au particles each of which is coated with an organic material and has an average particle size of about 10 nm and Au rods each of which has an aspect ratio of about 10, has a longitudinal length of about 100 nm, and is coated with an organic material, in a weight ratio of 1:1. In addition, the paste material described in Example 1 may be used for the bonding layers.

On these Au bonding layers, the semiconductor element 301 and ceramic insulating substrate 302 are placed and connected. At this time, heat at about 80° C. is applied for 60 minutes.

Al wires 305 each having a diameter of 300 μm are used to conduct wire bonding by the ultrasonic bonding method between gate electrodes, emitter electrodes or the like formed on each element 301 and a terminal 310 that is attached beforehand to electrodes 302a and 302b formed on the ceramic insulating substrate and the epoxy resin case 304. 311 is a thermistor element for sensing temperature and consists of the bonding layer 309 consisting of Au particles each of which is coated on its surface with an organic material and has an average particle size of about 10 nm and Au rods each of which has an aspect ratio of about 10, has a longitudinal length of about 100 nm, and is coated on its surface with an organic material, in a weight ratio of 1:1. Al wires 305 each having a diameter of 300 μm are used to conduct wire bonding between the electrodes 302a and the terminal 310, and connection to outside is formed.

In addition, a silicone bonding resin (not shown) is used to fix between the epoxy resin case 304 and the base member 303. A hollow 306′ is formed in a portion that is thick toward inside of the epoxy resin top 306. A hole 310′ is formed in the terminal 310. A screw (not shown) for connecting an insulated type semiconductor device 1000 to outside circuits is inserted in the hollow 306′ and the hole 310′. The terminal 310 is obtained by stamping out and forming a copper board to have a desired shape and plating the copper board with Ni. The terminal 310 is attached to the epoxy resin case 304.

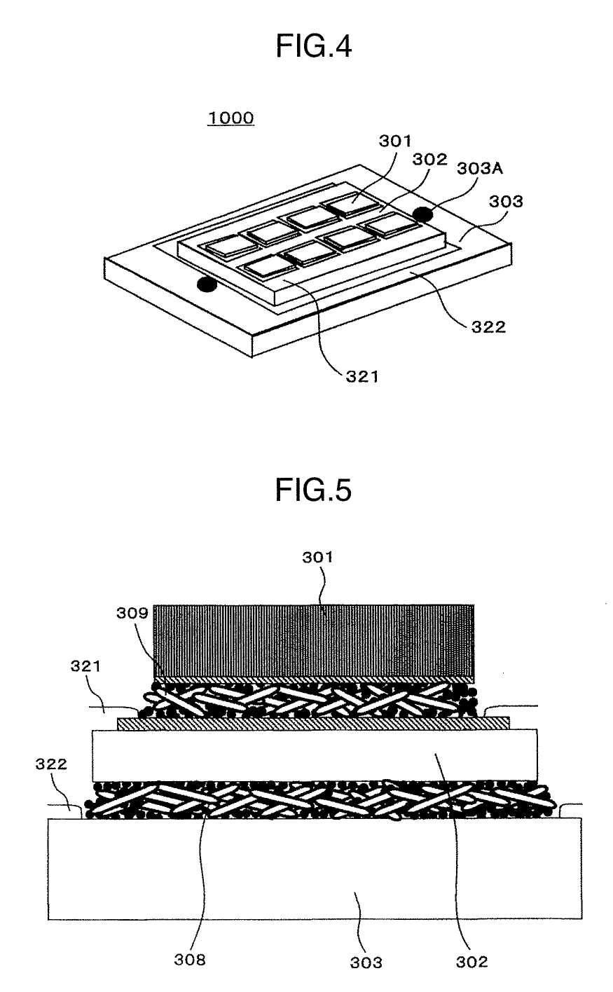

FIG. 4 illustrates a subassembly portion of the insulated type semiconductor device shown in FIG. 3. A ceramic substrate and semiconductor elements are mounted on composite materials as a base member 303. The base member 303 has mounting holes 303A in the periphery of the base member. The base member is made of Cu, and the surface of Cu is plated with Ni. A ceramic insulating substrate 302 is mounted on the base member 303 via the Au particles layer. Then MOSFET element 301 is mounted on the ceramic insulating substrate 302 via the Au particles layer.

FIG. 5 is an enlarged schematic section view showing the mounting position of the MOSFET element before bonding in FIG. 4. As shown in FIG. 5, the solution material or the sheet material in Example 1 may be used for the bonding layer. In addition, in order to prevent flowing of the solution containing the Au particles and the Au rods in Example 1 on applying the solution, a water repellent film 322 is provided on the base member 303 to correspond to the area on which the ceramic insulating substrate 302 is mounted. In addition, a water repellent film 321 is provided on the ceramic insulating substrate 302 to correspond to the area on which the semiconductor element 301 is mounted. Thus, flowing of the solution containing the Au particles on applying the solution is prevented. In addition, as with other Examples, the sheet material in Example 1 may be used for the bonding layer as necessary.

### Example 7

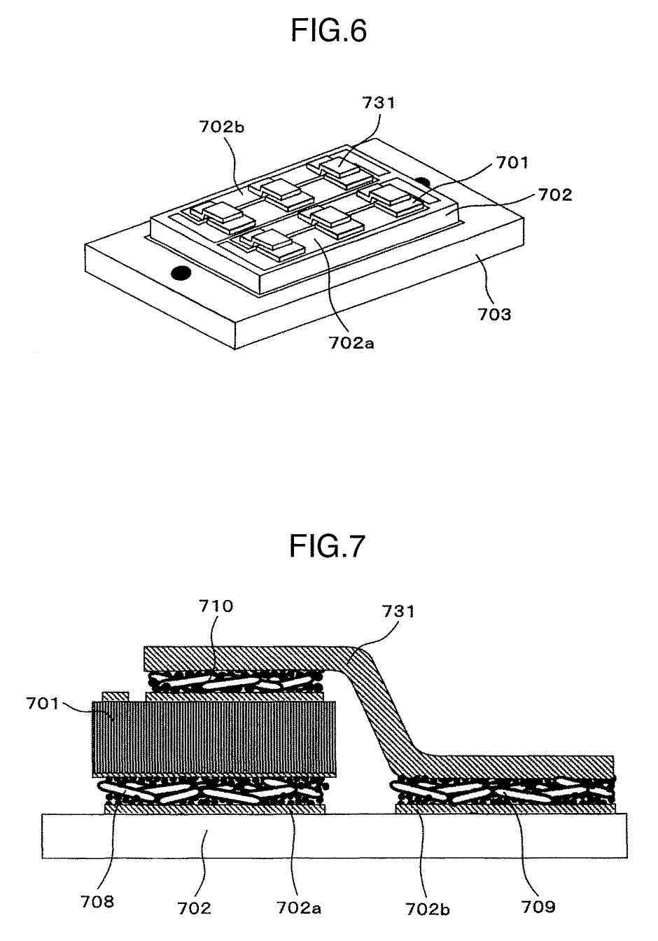

FIG. 6 illustrates a non-insulated type semiconductor device according to another embodiment of the present invention.

A semiconductor element 701 and a ceramic insulating substrate 703 are bonded via bonding layers consisting of Au particles each of which is coated on its surface with an organic material and has an average particle size of about 10 nm and Au rods each of which has an aspect ratio of about 10, has a longitudinal length of about 100 nm, and is coated on its surface with an organic material, in a weight ratio of 1:1. An emitter electrode of the semiconductor element is also connected via a bonding terminal 731, a copper wire 702b that is formed on the ceramic insulating substrate, the surface of the wire is plated with Au or Ni, and an Au particle layer.

FIG. 7 is an enlarged schematic section view showing a portion of mounting semiconductor elements before bonding in FIG. 6. As a terminal for bonding 731, a terminal obtained by plating a copper plate with Ni and further plating its surface with gold is used. A semiconductor element 701 is mounted on a wiring 702a of an insulating substrate. Then a sheet material consisting of Au particles each of which is coated on its surface with an organic material and has an average particle size of about 10 nm and Au rods each of which has an aspect ratio of about 10, has a longitudinal length of about 100 nm, and is coated on its surface with an organic material in a weight ratio of 1:1 is placed on an emitter electrode (the upper side) of the semiconductor element. Furthermore, the surface of copper wiring patterns formed on an insulating substrate 702 is subjected to a Ni plating treatment. In addition, the sheet material is placed on the emitter electrode of the semiconductor element and a portion plated with Au of the wiring 702b in which the portion that is connected to the emitter electrode via the terminal 731 is subjected to an Au plating treatment. Then the terminal for connecting 731 is mounted on the upper portion of the electrode of the sheet material consisting of Au particles each of which is coated on its surface with an organic material and Au rods each of which has an aspect ratio of about 10, has a longitudinal length of about 100 nm, and is coated on its surface with an organic material, and heat at about 80° C. is applied for 60 minutes, whereby the connection between the semiconductor element 701 and the wiring 702b of the insulating substrate is complete. In insulated type semiconductor devices, a large current passes through not only a collector electrode but also in the portion of an emitter electrode. Therefore, use of the terminal for bonding 731 having a large wiring width can further increase connection reliability on the side of the emitter electrode.

In addition, besides the semiconductor devices explained in Examples 6 and 7, for example, bonding using the bonding material according to the present invention when LEDs are mounted on a substrate can further increase a capability of heat radiation in comparison with the conventional solders or thermally conductive binding materials.

The present invention is explained specifically referring to Examples, however, not limited thereto. Examples may be combined or various changes may be made without departing from the scope of the present invention.

Furthermore, it should be understood by those skilled in the art that although the foregoing description has been made on embodiments of the invention, the invention is not limited thereto and various changes and modifications may be made without departing from the spirit of the invention and the scope of the appended claims.

1. A bonding material comprising metal fibers each of which is coated on its surface with an organic material or a metal oxide, has an aspect ratio not more than 2, and has a longitudinal length equal to or less than 100 μm; and metal particles each of which is coated on its surface with an organic material or a metal oxide, has an aspect ratio equal to or less than 1.5, and has a particle size equal to or less than 100 nm, wherein sintering of the metal particles forms metallic bonds between the bonding material and surfaces of members to be bonded, thereby bonding the members to be bonded together.

2. The bonding material according to claim 1, having a shape of a sheet.

3. The bonding material according to claim 1, comprising metal fibers each of which is coated on its surface with an organic material or a metal oxide, has an aspect ratio not more than 2, and has a longitudinal length equal to or less than 100 nm.

4. The bonding material according to claim 1, wherein the metal fibers and the metal particles are dispersed in an organic solvent.

5. A bonding material comprising metal fibers each of which is coated on its surface with an organic material or a metal oxide, has an aspect ratio not more than 2, and has a longitudinal length equal to or less than 100 nm, wherein sintering of the metal fibers forms metallic bonds between the bonding material and surfaces of members to be bonded, thereby bonding the members to be bonded together.

6. The bonding material according to claim 5, having a shape of a sheet.

7. The bonding material according to claim 5, comprising metal particles each of which is coated on its surface with an organic material or a metal oxide, has an aspect ratio equal to or less than 1.5, and has a particle size equal to or less than 100 nm.

8. A bonding material comprising a mixture of metal fibers each of which is coated on its surface with an organic material or a metal oxide, has an aspect ratio not more than 2, and has a longitudinal length equal to or less than 100 μm; and metal particles each of which is coated on its surface with an organic material or a metal oxide, has an aspect ratio equal to or less than 1.5, and has a particle size equal to or less than 100 nm.

9. The bonding material according to claim 8, having a shape of a sheet.

10. An electronic device wherein a metal wiring formed on a surface of a substrate and an electronic component on a surface of which a metal electrode is formed are bonded together via a layer made of the bonding material according to claim 1.
